(19) United States
(12) Patent Application Publication
(10) Pub. No.: US 2008/0163212 A1
(43) Pub. Date: Jul. 3, 2008

(54) PARALLELED MANAGEMENT MODE INTEGRITY CHECKS

(76) Inventors: Vincent J. Zimmer, Federal Way, WA (US); Ravi Sahita, Beaverton, OR (US); Alan D. Ross, Shingle Springs, CA (US)

Correspondence Address: SCHWABE, WILLIAMSON & WYATT, P.C., PACWEST CENTER, SUITE 1900, 1211 S.W. FIFTH AVE., PORTLAND, OR, 97204, US

(21) Appl. No.: 11/618,294

(22) Filed: Dec. 29, 2006

(51) Int. Cl. G06F 9/46

(52) U.S. Cl. 718/100

(57) ABSTRACT

Embodiments of apparatuses, articles, methods, and systems for providing a management mode integrity check are generally described herein. Other embodiments may be described and claimed.

### FIELD

Embodiments of the present invention relate generally to the field of platform security, and more particularly to an integrity measurement module with components operating in parallel in a management mode of a platform.

### BACKGROUND

Platforms are becoming targets of increasingly sophisticated attacks that range from attempts to crash a software program to subversion of the software program for alternate purposes. Presently, intrusion prevention and detection systems (IDSs) rely heavily on host resident software components such as anti-virus agents. However, these host-resident software components are often targeted early in an attack, thereby compromising their ability to detect an attack on other programs. Other proposals for securing software programs involve creation of multiple execution environments and sequestering protected programs into a protected execution environment. For example, a management virtual machine (VM) may run integrity check components in parallel with user applications running in an application VM. However, this approach is dependent on an operating system (OS) vendor and typically requires multiple operating systems.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 illustrates a platform capable of management mode integrity checks in accordance with an embodiment of the present invention;

FIG. 2 illustrates an integrity manifest in accordance with an embodiment of the present invention;

FIG. 3 illustrates a flowchart depicting system integrity service operations in accordance with an embodiment of the present invention;

FIG. 4 illustrates a flowchart depicting an integrity check in accordance with an embodiment of the present invention; and

FIG. 5 illustrates a parallel implementation of an integrity measurement module in accordance with various embodiments of this invention.

### DETAILED DESCRIPTION

Embodiments of the present invention may provide a method, article of manufacture, apparatus, and system for providing paralleled management mode integrity checks.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific devices and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

In providing some clarifying context to language that may be used in connection with various embodiments, the phrase “A/B” means (A) or (B); the phrase “A and/or B” means (A), (B), or (A and B); and the phrase “A, B, and/or C” means (A), (B), (C), (A and B), (A and C), (B and C) or (A, B and C).

As used herein, a generic reference to a “component” may refer to a hardware, a software, and/or a firmware component employed to obtain a desired outcome. Although only a given number of discrete components may be illustrated and/or described, such components may nonetheless be represented by additional components or fewer components without departing from the spirit and scope of embodiments of the invention.

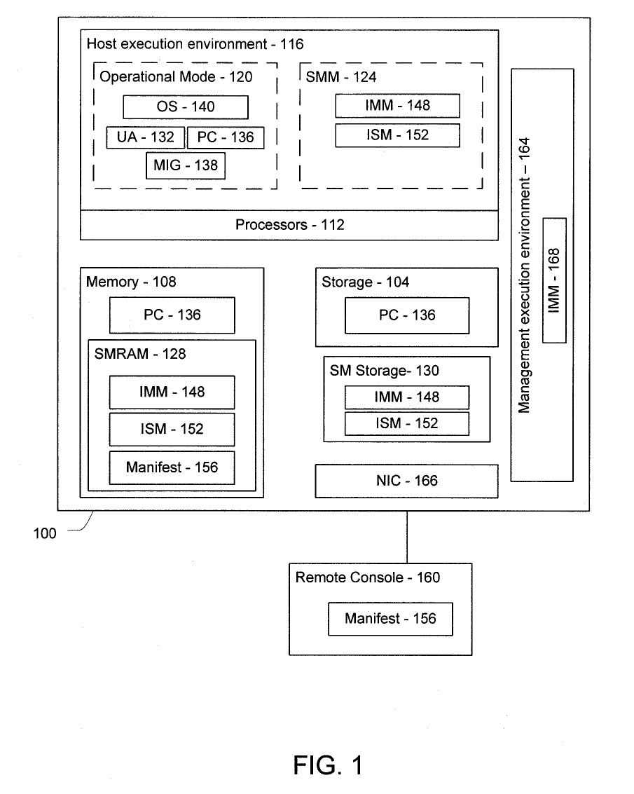

FIG. 1 illustrates a platform 100 capable of paralleled management mode integrity checks in accordance with an embodiment of the present invention. In this embodiment, the platform 100 may include storage 104 to store persistent copies of the components, memory 108 to store temporal copies of the components, and processors 112 to process the components. The storage 104, memory 108, and processors 112 may be operatively coupled to one another in any of a variety of ways including through one or more buses.

In various embodiments, storage 104 may include integrated and/or peripheral mass storage devices, such as, but not limited to, disks and associated drives (e.g., magnetic, optical), universal serial bus (USB) storage devices and associated ports, read-only memory (ROM), non-volatile semiconductor devices, etc.

In various embodiments, storage 104 may be a storage resource physically part of the platform 100 or it may be accessible by, but not necessarily a part of, the platform 100. For example, the storage 104 may be accessed by the platform 100 over a network.

In various embodiments, the memory 108 may include RAM, dynamic RAM (DRAM), static RAM (SRAM), synchronous DRAM (SDRAM), dual-data rate RAM (DDRRAM), etc.

In various embodiments, the processors 112 may include single-core processors, multiple-core processors, controllers, application-specific integrated circuits (ASICs), etc.

The processors 112 of the platform 100 may provide a host execution environment 116 in either an operational mode 120 (which may include, e.g., a protected mode, a real-address mode, and/or a virtual mode) or a management mode, e.g., system management mode (SMM) 124. The SMM 124 may be a privileged execution mode of the processors 112 with portions of the memory 108 corresponding to components of the SMM 124 being sequestered from components operating in the operational mode 120 via hardware protections. In an embodiment the sequestered portions of memory 108 may be system management random access memory (SMRAM) 128.

The code for the components running in the SMM 124 may be provided as firmware, for example, written by the original equipment manufacturer (OEM) of the platform 100 and ship with the platform 100. The SMM code may loaded from system management (SM) storage 130, e.g., flash memory, into the SMRAM 128 at runtime and may be install-time verified by cryptographic signing and/or runtime-checked via code signing.

In an embodiment a user application 132 and/or a protected component 136 may be executed under the control of an operating system 140 operating the processors 112 in the operational mode 120. The user application 132 may be a component providing user functionality associated with the platform 100. The protected component 136 may represent one or more components such as, but not limited to, a device driver, a kernel security agent (e.g., a firewall), a security service (e.g., a virtual private network), an operating system (OS) kernel invariant, or some other software component that registers for system integrity services (SIS).

In an embodiment, the host execution environment 116 may be switched from the operational mode 120 to the SMM 124 at an invocation of a management interrupt, e.g., a system management interrupt (SMI), transmitted to the processors 112 by a management interrupt generator (MIG) 138. In an embodiment, the SMI may be broadcast to all of the processors 112 of the platform 100 and the entire host OS sessions (virtual machines (VMs) and/or bare metal OSs).

The SMI may be a non-maskable external interrupt that is signaled through an SMI# pin on one of the processors 112 or through an SMI message received through an advanced programmable interrupt controller (APIC). In various embodiments, some of which may be described in more detail below, the MIG 138 may be integrated into other components of the operational mode 120 and/or implemented in other modes of the host execution environment 116 or elsewhere on the platform 100. In various embodiment, the MIG 128 may provide use-driven SMIs, event-driven SMIs, and/or periodic SMIs.

Invocation of the SMM 124 via a periodical SMI may be done with varying periodicity (e.g., from 10s of microseconds to seconds). In some embodiments, this invocation may be independent of the host OS 140 and may ensure that integrity check code of the SMM 124 may have the opportunity to verify the host OS 140 and/or other components.

When an SMI is detected by the processors 112, the current state of the processors 112, e.g., the processors' context, may be saved in the SMRAM 128. At the initialization of SMM 124, SMI handlers stored in SM storage 130 may be loaded into the SMRAM 128.

In an embodiment, the SMI handlers of the SMM 124 may provide functions of various SIS components. In an embodiment, these components may include an integrity measurement module (IMM) 148 and an integrity services module (ISM) 152. The SIS components may provide assurances that the protected component 136 is operating as expected and has not been subjected to an unauthorized modification. Executing these SIS components in the SMM 124 may be provide these assurances without the aforementioned vulnerabilities/inefficiencies associated with providing IDSs in a host execution environment or in a separate execution environment.

While the embodiments described herein discuss the SIS operations being implemented in SMM 124 through an SMI, these operations may also be implemented in other management modes of the host execution environment 116, e.g., in a processor management mode (PMM) through a processor management interrupt (PMI), in a similar fashion.

SIS operations provided by the SIS components operating in the SMM 124 may include checks related to, e.g., locality, integrity, and execution state. Locality may refer to the location in memory 108 where the protected component 136 (including its executable code as well as its static and dynamic program data) resides. Integrity may refer to whether the protected component 136 has been modified from its original state. Execution state may refer to whether the protected component 136 is running and is being scheduled to run by the OS 140 over time.

When the SIS components verify these attributes, the system may infer that the protected component 136 (excluding unprotected dynamic data) has not been compromised and may be allowed to make use of any component-specific secrets being protected by the SIS components.

When the protected component 136 is initially loaded into memory 108 it may have SIS-specific initialization code that is executed in order to register the protected component 136 for SIS services. This code may provide a registration message to the IMM 148 that includes locations of certain sections in memory 108 (which may include virtual memory locations) that comprise measured segments of the protected component 136.

When the protected component 136 is registered with the IMM 148 the IMM 148 may also receive a location of an integrity manifest 156 that is associated with the protected component 136 and loaded into SMRAM 128 at initialization of the protected component 136. This integrity manifest 156 may be used by the IMM 148 for integrity verification, e.g., integrity validation procedures (IVPs), of the protected component 136 as will be described in further detail below. In some embodiments, this initial loading of the protected component 136 and/or the integrity manifest 156 may be mediated by initialization code of the platform 100, e.g., basic input/output system (BIOS), boot loader, etc.

The protected component 136 may have both integrity constrained data and/or code items (CDIs) and unconstrained data and/or code items (UDIs). The integrity manifest 156 may provide a signed summary description of monitored sections, e.g., the CDIs, of the protected component 136 when the protected component 136 is loaded into memory 108.

While the integrity of the CDIs is constrained, the CDIs themselves may not be static. That is, certain transformations of the items of the protected component 136 may be permissible if they are done following various security principles of the platform 100. In an embodiment, security principles related to CDIs may be determined by the Clark-Wilson integrity model (CW model). In the CW model, “subjects” may transform data in the system and act on data by calling transformation procedures (TPs), which are sequences of atomic actions in the system.

The CW model sets up the following security principles: IVPs may be available for validating any CDI; application of a TP to a CDI preserves the integrity of the CDI; a CDI may be changed only by a TP; subjects may only initiate certain TPs on certain CDI, e.g., if we have policy data for a layer, then the policy data may be changed only through the actions of a well-known and analyzed TP; certain TPs on UDIs can produce CDIs as output, e.g., a guard can accept data of unknown integrity and verify or transform it into a CDI; subjects performing a TP may be authenticated, e.g., the platform 100 may enforce some authentication policy on an entity seeking to edit the k-mode root store; only special subjects (security administrators) may be able to change any authorization related lists, e.g., a layer wide policy such as the type of authentication permitted at each layer.

Therefore, in accordance with various embodiments, the CW principles may be employed when evaluating the integrity of the monitored sections of the protected component 136, including permissible modifications to the integrity manifest 156 associated with the protected component 136. For example, if a CDI in the integrity manifest 156 needs to be changed, a TP may do so when proxied via a call from OS 140 into the IMM 148. Otherwise, a CDI change may be considered an attack. A security administrator may be the party to make this request to the IMM 148 via a shared secret stored by the IMM 148 and the OS 140 (e.g., a password) or some other proof of authority (e.g., administrator signs some data with a private key and the IMM 148 uses a corresponding public key in the SMRAM 128 to validate the signature to verify that the administrator owns the correct version of the key).

The integrity manifest 156 may provide the IMM 148 with a snapshot of the appearance of CDIs in memory 108 to facilitate the IVPs. The appearance of the CDIs in memory 108 may depend on two factors: the original contents of the sections that comprise the CDIs in the storage 104 and the relocations performed on these sections by a loader of the OS 140. Thus, the integrity manifest 156 may describe these two entities for each of the CDIs.

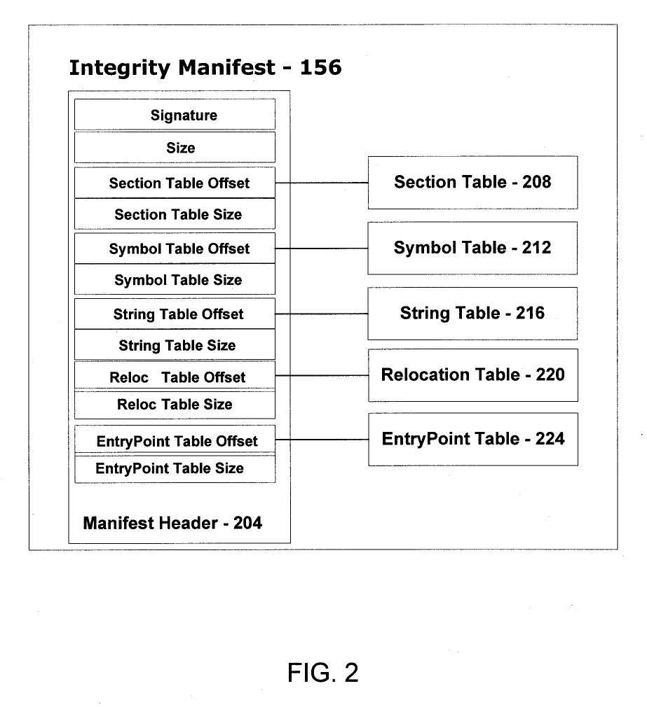

FIG. 2 illustrates the integrity manifest 156 in accordance with an embodiment of this invention. The integrity manifest 156 may include a header 204 providing offsets and sizes of tables of the integrity manifest 156. Additionally, the header 204 may include the size of the integrity manifest 156 and a signature for proving the integrity of the integrity manifest 156 itself as it is transferred to the IMM 148.

The integrity manifest 156 may include tables such as a section table 208, a symbol table 212, a string table 216, a relocation table 220, and an entry point table 224.

Each entry in the section table 208 may include a unique numeric identifier for the section, a bit-field describing properties of the section, and an integrity check value (ICV), e.g., a secure hash algorithm (SHA)-1 hash or a SHA-256 hash, of the un-relocated image of the section. In some embodiments a keyed-hash message authentication code (HMAC) may be additionally/alternatively used.

In various embodiments, the symbol table 212 may include a unique numeric symbol identifier, the section to which the symbol belongs, and an offset of the symbol in that section.

In various embodiments, the string table 216 may include a size field indicating the total size of the string table 216 and null-terminated strings that may be pointed to by symbols in the symbol table 212.

In various embodiments, the relocation table 220 may include a numeric identifier of the section to which the relocation applies, an offset of the location in the section that needs to be relocated, a numeric identifier of the symbol on which the relocation is based, and a numeric relocation type indicating the relocation action corresponding to that entry.

In various embodiments, the entry point table 224 may include, e.g., an address of various entry points relative to an image base when an executable file is loaded into memory.

In some embodiments, the integrity manifest 156 may be accessed from a remote console 160 via a network interface card (NIC) 166 of the platform. This may be done at the initialization of the platform 100. Accessing the integrity manifest 156 from the remote console 160 upon initialization of the platform 100 may allow for periodic updates to the integrity manifest 156.

The remote console 160 may be a network management entity that performs other tasks such as authenticating the platform 100, allowing the platform 100 to access a private network, etc. In an embodiment, the remote console 160 may provide certain administrative management functions through accessing one or more components operating in a management execution environment 164 of the platform 100.

The management execution environment 164 may provide out-of-band (OOB) access to the platform 100 from the remote console 160 via the NIC 166. This access may be independent of the state of the OS 140. In various embodiments, this management execution environment 164 may be a hard partition, e.g., implemented through one or more processors other than the processors 112, or a virtual partition, e.g., implemented through a VM manager (VMM) managing a number of VMs corresponding to a number of execution environments.

In some embodiments, code of the SMM 124 may utilize the OOB access of an agent in the management execution environment 164 to provide the SMM 124 with its own integral networking to communicate with the remote console 160. In other embodiments, the SMM 124 may utilize a variant of an extensible firmware interface (EFI) networking drivers to communicate with the remote console 160.

In some embodiments, the management execution environment 164 may have another IMM 168 to provide initial integrity measurements of the SIS components in the SM storage 130. These initial integrity measurements may ensure that the components of the SM storage 130 have a level of trust that is desired for providing the SIS operations for the platform 100. The integrity measurements of the SIS components may be performed at initialization of the platform 100.

With the integrity of the SIS components ensured, the SMM 124 may provide a trusted environment for the IMM 148 to reference the integrity manifest 156 in order to verify the integrity of the CDIs over the course of the protected components 136 in-memory lifetime. These integrity checks may ensure that the protected component 136 is operating as expected, e.g., has not been subject to an unauthorized modification. The first integrity check may be performed at registration time when the protected component 136 is loaded into memory 108. After that, the integrity of the protected component 136 may be checked periodically, or on a use-driven basis as it executes.

When the SIS components receive a registration request from the protected component 136 and the host execution environment 116 switches into the SMM 124, the IMM 148 may read the integrity manifest 156 from SMRAM 128 using, e.g., a virtual memory reconstitution service (VMRS). If the signature on the integrity manifest 156 is verified as correct, the IMM 148 may read the sections of the protected component 136 as specified in the integrity manifest 156. Using the relocation table 220, the IMM 148 may reverse the relocation fix-ups in each section. The IMM 148 may then compute an ICV for each section and compare them with the ICV from the appropriate section entry in the section table of the integrity manifest 156. If all of these match, then the IMM 148 may assert that the protected component 136 has not been modified from the time it was signed by the manufacturer.

Subsequent integrity verifications may be performed whenever the protected component 136 requests SIS services via an SMI. At these times, the IMM 148 may be triggered to verify the integrity of the protected component 136 prior to allowing the protected component 136 to complete an integrity services operation.

In an embodiment the ISM 152 may perform locality verification in order to prevent spoofing of service requests to the SIS components. This locality verification may ensure that a component requesting SIS services is the same component that registered for those services.

A component in the operational mode 120 that wishes to use SIS services, may trigger an SMI of an appropriate type. After receiving an SMI call, the ISM 152 may identify the source of the SMI and subsequently the component that triggers the SMI. The ISM 152 may identify the source of the SMI by examining register values stored in SMRAM 128 when the host execution environment 116 switches to the SMM 124. These register values may provide address information on the source of the SMI invocation. Once the source of an SMI is identified, the ISM 152 may verify whether the component requesting SIS services is a registered component as previously recorded in the registered component list (at initial registration).

In an embodiment, the ISM 152 may also be responsible for securely updating and verifying protected component 136 execution state. In order to show that the protected component 136 is executing, the protected component 136 may need to periodically generate an indicator (a “heartbeat”) to the SIS components that it is alive and executing. To mitigate the inherent vulnerability of these heartbeats, the ISM 152 may test the locality of the request for the heartbeat update. Combined with the integrity checks, this may prevent an attacker from forging a heartbeat update. In this process, the signature generated by the ISM 152 may be returned to the protected component 136, which may be appended to the heartbeat message sent to the IMM 148 for verification. If an attacker tries to forge the heartbeat message, the forgery may be detected due to an incorrect signature, and the IMM 148 may trigger a policy-based remedial action.

In various embodiments, the ISM 152 may be additionally/alternatively responsible for other SIS services related to, but not limited to, component registration, updates to protected dynamic application data, etc.

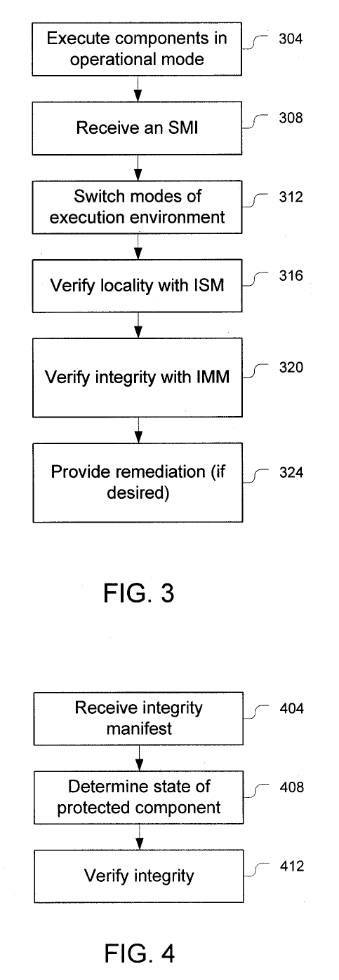

FIG. 3 illustrates a flowchart depicting some of the SIS operations discussed above in accordance with an embodiment of this invention. In this embodiment, components, e.g., user application 132 and/or protected component 136, may be executing in the operational mode 120 of the host execution environment 116 under the control of the OS 140 in block 304. The processors 112 may receive an SMI in block 308. This SMI may be generated by a request for SIS services from the protected component 136 or through periodically scheduled or event-driven SIS services. As a result of the SMI, the processors 112 may switch the host execution environment 116 from the operational mode 120 to the SMM 124 in block 312. As discussed above, the context of the processors 112 may be saved into the SMRAM 128 upon switching between the modes.

If the modes of the host execution environment 116 are switched as a result of a request from the protected component 136, the ISM 152 may verify the locality of the request in block 316. In some embodiments, the ISM 152 may also verify the execution state of the protected component 136.

The IMM 148 may verify the integrity of the protected component 136 in block 320. If any of the SIS checks warrant remediation, it may be provided by the SIS components in block 324. In an embodiment, the SIS components may simply provide a remediation flag with remediation measures being executed from the management execution environment 164.

FIG. 4 illustrates a flowchart depicting an integrity check by the IMM 148 in accordance with an embodiment of this invention. In this embodiment, the IMM 148 may receive the integrity manifest 156 that is stored in SMRAM 128 in block 404. The IMM 148 may determine the present state of the protected component 136 in block 408. The present state may be determined by reference to the context of the processors 112 stored in SMRAM 128 upon switching of the modes of the host execution environment 116. The IMM 148 may perform various IVPs to determine if the present state of the protected component 136, and in particular the CDIs, appears as it should compared to the integrity manifest 156. If the IVPs are successful, the IMM 148 may provide a verification of the integrity of the protected component 136 in block 412.

As can be seen, the SIS operations, and in particular the integrity check done by the IMM 148, may be a memory intensive task. And while providing the IMM 148 in the SMM 124 does provide a secured platform-based verification of the integrity of components independent of the OS 140, it does suspend the user application 132 while these integrity checks are being performed. Accordingly, to reduce the IMM overhead so that real-time integrity check may be performed frequently, with little or no impact on the performance and/or throughput of the user application 132, the SIS operations may be distributed over multiple processors (MPs), e.g., two or more processors. In an embodiment, more than one processor may be implemented in a single package and may therefore also be referred to as a multicore processor. As used herein, “MP” may refer to either multiple cores and/or multiple distinct processors.

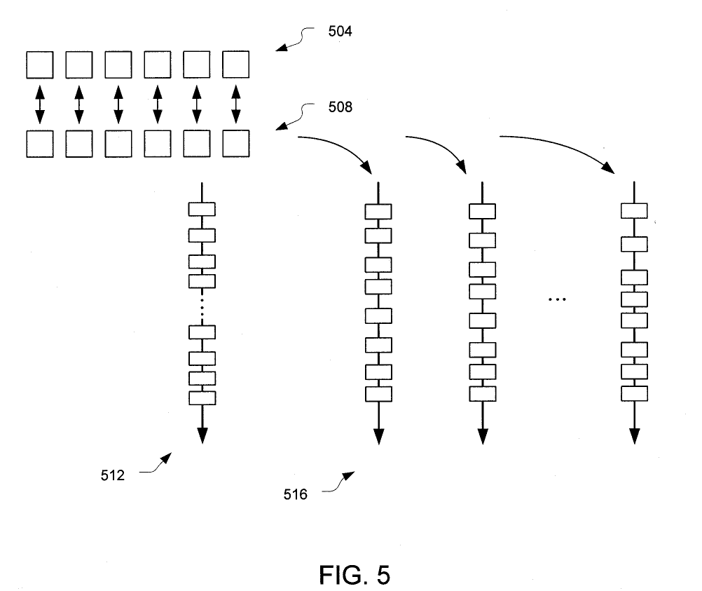

FIG. 5 illustrates a paralleled implementation of the operations of the IMM 148 in accordance with an embodiment of the present invention. In SMM 124, SMI handlers may be responsible for comparing ICVs 504 of CDIs of the protected component 136 with ICVs 508 of CDIs of the integrity manifest 156. The dispatch thread of this integrity check may be depicted as SMI thread 512. The SMI handlers responsible for these comparisons may be distributed among a number of processing threads 516, with each thread corresponding to a respective processor, for concurrent processing. This paralleled implementation of the components of the IMM 148 may facilitate this low-overhead integrity checks from the SMM 124.

In an embodiment, there may be a number of integrity manifests similar to the integrity manifest 156. In this embodiment, each manifest or manifest section may be mapped to a respective processing thread to provide this concurrent processing.

In an embodiment, any unutilized processing threads may be put into a sleep state (low power) while the other threads do the integrity checks.

At the end of the SMI thread 512, an SMI handler may execute a resume (RSM) instruction that causes the processors 112 to switch back to the operational mode 120 and resume executing any interrupted software component, e.g., the user application 132.

While the above embodiments discuss SMI events related to SIS operations, embodiments may include SMI handlers for other types of management operations related to, e.g., power management, hardware control, or proprietary OEM designed code.

Furthermore, while the above embodiments discuss the IMM 148 measuring the integrity of components in the operational mode 120 of the platform 100, other embodiments may additionally/alternatively include the IMM 148 measuring integrity of components in other modes/execution environments of the platform 100. For example, in an embodiment, at the start-up of the platform 100 a trusted platform module (TPM), which may be implemented in another execution environment with its own processor, may include pre-OS code to measure or record a SHA-1 hash of code and data into platform configuration registers (PCRs). In this embodiment, the IMM 148 may operate to perform IVPs of CDIs of the TPM on an event, use, and/or periodic basis.

Although the present invention has been described in terms of the above-illustrated embodiments, it will be appreciated by those of ordinary skill in the art that a wide variety of alternate and/or equivalent implementations calculated to achieve the same purposes may be substituted for the specific embodiments shown and described without departing from the scope of the present invention. Those with skill in the art will readily appreciate that the present invention may be implemented in a very wide variety of embodiments. This description is intended to be regarded as illustrative instead of restrictive on embodiments of the present invention.

What is claimed is:

1. A method comprising:
executing one or more user applications under control of an operating system operating a processor in an operational mode;
switching the processor to a management mode not under control of the operating system; and
executing an integrity measurement module (IMM) to measure an integrity of a protected component, independent of the operating system, while in the management mode by employing the processor and at least one other processor, with a first portion of the IMM executing on the processor and at least one other portion correspondingly executing on the at least one other processor.

2. The method of claim 1, wherein said executing an IMM to measure an integrity of a protected component comprises:
retrieving, by the IMM, an integrity manifest associated with the protected component;
retrieving, by the IMM, a state of the protected component occurring at a time that the processor was switched to the management mode; and
comparing the integrity manifest to the state of the protected component.

3. The method of claim 2, wherein said comparing the integrity manifest to the state of the protected component comprises
comparing one or more constrained data and/or code items (CDIs) of the integrity manifest to one or more CDIs of the state of the protected component.

4. The method of claim 3, further comprising:
updating, by a transitioning procedure operating the processor in the management mode, a selected CDI of the one or more CDIs of the integrity manifest, based at least in part on a request from the operating system.

5. The method of claim 1, further comprising:
retrieving, at initialization of the protected component, an integrity manifest associated with the protected component from a console via a network interface of a platform hosting the processor.

6. The method of claim 5, further comprising:
storing the integrity manifest in an area of memory that is inaccessible to the operating system.

7. The method of claim 1, wherein said executing of one or more user applications and said executing of an IMM are done in a host execution environment and the method further comprises:
executing another IMM, in a management execution environment that is partitioned from the host execution environment, to measure an integrity of the IMM.

8. The method of claim 1, further comprising:
powering-down another processor not executing a portion of the IMM.

9. The method of claim 1, wherein the protected component is a component of a trusted platform module.

10. A machine-accessible medium having associated instructions, which, when executed results in an apparatus:
executing an integrity measurement module (IMM) to measure an integrity of a protected component, independent of an operating system configured to control operation of one or more user applications by operating a processor of the apparatus in an operational mode, while in a management mode not under control of the operating system by employing the processor and at least one other processor, with a first portion of the IMM executing on the processor and at least one other portion correspondingly executing on the at least one other processor.

11. The machine-accessible medium of claim 10, wherein the associated instructions, when executed, further results in the apparatus;
executing an integrity services module (ISM) to verify a locality of the protected component while in the management mode.

12. The machine-accessible medium of claim 10, wherein the associated instructions, when executed, results in the apparatus executing an IMM to measure an integrity of a protected component by:
retrieving an integrity manifest associated with the protected component;
retrieving a state of the protected component occurring at a time that the processor was switched to the management mode from the operational mode; and
comparing the integrity manifest to the state of the protected component.

13. The machine-accessible medium of claim 10, wherein the associated instructions, when executed, further results in the apparatus:
retrieving, at initialization of the protected component, an integrity manifest associated with the protected component from a console via a network interface of the apparatus.

14. An apparatus comprising:
an operating system configured to operate a processor in an operational mode to control one or more user applications;
a management interrupt generator configured to transmit an interrupt to the processor to switch the processor to a management mode not under control of the operating system; and
an integrity measurement module (IMM) configured to operate the processor and at least one other processor in the management mode to measure an integrity of a protected component, independent of the operating system, with a first portion of the IMM executing on the processor and at least one other portion correspondingly executing on the at least one other processor.

15. The apparatus of claim 14, wherein the protected component includes the management interrupt generator.

16. The apparatus of claim 15, further comprising:
an integrity services module (ISM) to verify a locality of the protected component.

17. The apparatus of claim 14, wherein the IMM is further configured
to access an integrity manifest associated with the protected component,
to compare the integrity manifest to the protected component; and
to measure the integrity of the protected component based at least in part on comparison of the integrity manifest to the protected component.

18. The apparatus of claim 17, wherein the integrity manifest includes one or more constrained data and/or code items (CDIs) and the operating system is further configured to
request a transitioning procedure in the IMM to make a change to at least a first one of the one or more CDIs.

19. A system comprising:
a first and a second processor;
a mass storage device operatively coupled to at least the first processor and storing a first set of instructions that when accessed by the first processor result in an operating system operating the processor in an operational mode to control one or more user applications;
a management interrupt generator configured to transmit an interrupt to the first processor to switch the first processor to a management mode not under control of the operating system; and
system management storage operatively coupled to the first and second processor and storing a second set of instructions that when accessed by the first and second processors in parallel result in an integrity measurement module (IMM) operating the first and the second processors in the management mode to measure an integrity of a protected component, independent of the operating system, with a first portion of the IMM executing on the first processor and a second portion of the IMM executing on the second processor.

20. The system of claim 19, further comprising:
a network interface; and
the second set of instructions, when accessed by the first and second processors, further results in the IMM operating the first and second processors in the management mode to measure an integrity of the protected component by accessing an integrity manifest from a remote console and comparing the integrity manifest to the protected component.

21. The system of claim 19, further comprising:
a management execution environment, partitioned from an execution environment including the operational and management modes, the management execution environment including another IMM to measure an integrity of the IMM operating in the management mode.
